(19) United States
(12) Patent Application Publication
(10) Pub. No.: US 2024/0090523 A1
(43) Pub. Date: Mar. 21, 2024

(54) PROCESS FOR MANUFACTURING NON-DAIRY CHEESE, AND NON-DAIRY CHEESE

(71) Applicant: ODDLYGOOD GLOBAL OY, Helsinki (FI)

(72) Inventors: Kaity-Marin LEHTONEN, Helsinki (FI); Outi MÄKINEN, Helsinki (FI)

(21) Appl. No.: 18/254,201

(22) PCT Filed: Nov. 26, 2021
(86) PCT No.: PCT/FI2021/050814

§ 371 Date: May 24, 2023

(30) Foreign Application Priority Data
Dec. 1, 2020 (FI) 20206230

(51) Int. Cl. A23C 20/02

(52) U.S. Cl. CPC A23C 20/025

(57) ABSTRACT

The present invention concerns the field of food technology. The invention relates to an edible plant-based food product, particularly non-dairy cheese, which is suitable as a dairy-alternative product, a process for the manufacture thereof and uses related thereto.

### FIELD OF THE INVENTION

The present invention concerns the field of food technology. The invention relates to an edible plant-based food product, particularly non-dairy cheese, which is suitable as a dairy-alternative product, a process for the manufacture thereof and uses related thereto.

### BACKGROUND OF THE INVENTION

Some people need to avoid dairy-based products for reasons, such as lactose intolerance or allergy to milk protein. In addition, the number of consumers who voluntarily prefer a vegetarian or vegan diet is increasing. Plant-based food alternatives are also beneficial from an environmental standpoint because they can help in ensuring a sustainable development by utilizing renewable resources.

Various alternatives to dairy-based products have been introduced on the market and there is an increasing demand for such dairy-alternative or dairy-replacement products, such as plant-based products.

Non-dairy cheeses are typically produced from starches and fat or nut paste and cold-setting polysaccharides, in addition to other components. Also, other ingredients (e.g. flavouring, sugars, stabilisers etc.) and low levels of protein are used. The general process is as follows: mixing the ingredients, heating the mass, and setting of the mass in moulds or final packaging (US20190037872A1; US20180000105A1; US2017/0172169A1).

In Mintel's Global New Product Database, 269 vegan cheese alternative product (blocks, slices and shreds) launches can be found between April 2018 and April 2020. Out of these, 233 products were starch and saturated fat-based and contained <2% protein; 27 products were nut paste based and contained 2-16% protein, 5 were mainly starch and fat-based but contained slightly more protein from added protein-rich powders, and 2 were saturated fat-based with significant protein content from soy curd and -protein (protein to fat ratio 1:3).

Example of starch based non-dairy cheese is Valio OddlyGood cheese. The process of producing OddlyGood cheese is shown in FIG. 1. Fat, starch, water and minor ingredients are mixed and cooked, cooled, settled, cut and packed. The composition of such starch-based products is not comparable to dairy cheese, that comprises of protein and fat. In addition to having poor nutritional composition, starch-based cheese replicas are known to have unpleasant sensory characteristics, such as rubbery mouthfeel, that even makes many committed vegans avoid these products. Unlike other dairy replicas (yoghurt, milk, ice cream), cheese analogues have still not reached the sensory quality necessary to make them acceptable in the mainstream: as Mintel reports, non-dairy cheese posts largest gaps in consumer perception against its dairy equivalent compared to other dairy sub-categories (Mintel 2019).

Another method for producing non-dairy cheese that is widely known and published in various cookbooks, is setting a nut paste with agar or another gelling polysaccharide. Traditional protein-based bean curds (e.g. tofu and beske) are produced by heating bean milk, coagulating it with salts and pressing the granular curd using cheesecloth or sieve to drain whey (Oyeyinka et al., 2019). Silken tofu type of curd coagulates in final packaging and is not pressed, hence yielding a very delicate gel. A packed tofu coagulated with transglutaminase has been patented (U.S. Pat. No. 6,042,851A). Tofu does not resemble cheese sensorically, and it associated as cooking ingredient. Nut paste based “artisan” cheeses are available from small-scale producers and especially soft cheese replicas are generally considered good. The price of such products can be very high (e.g. cashew-based brie-type cheese from Juustotytot (Finland) costs 80€/kg and Classic Brie by Uncreamery (US) costs $71/kg). As nuts are allergens, consumers with nut allergies cannot use them. Also, the possibilities to use nut ingredients are limited in factories that produce a range of other products, as allergen handling and cross-contamination risks complicate production.

Production of protein-based non-dairy cheese is possible by gelling the protein with cross-linking enzymes. The resulting non-dairy cheese curd is then processed similarly to dairy cheese: cutting and heating of curd, transferring curd granules to molds and pressing. A very long processing time (24 h) under high pressure is required for sufficient whey drainage (EP2731451B1/US901194962). A similar process using “plant-origin rennet” has been patented (EP3366144A1). Because it is challenging to obtain a continuous, strong structure after breaking the curd, the methods described in these patents are better suited for the production of soft cheese replicas, like goat's cheese or ricotta-types. Protein-based cheese replicas made of plant proteins also have unpleasant off-flavors such as beany, cardboard and bitter flavours, that cannot be removed by microbial ripening alone.

In an application (WO2019133679A2), a formulation for making a protein-based structure with the right compression properties using high acyl gellan gum is described. The process appears to be cooked mixture containing protein, starch and gellan gum, that is not processed like dairy cheese. Another application (CA3058199A1) describes a process where lactic acid bacteria fermented non-dairy milk is mixed with other ingredients (starch(es), gum(s), oil), emulsified, and heated under high shear. Even with improved compressibility, these products would have the same limitations as other starch-based cheese replicas.

### SUMMARY OF THE INVENTION

The object of the present invention is to overcome problems related to the prior art of producing plant-based dairy-alternative products, especially cheese.

In dairy cheese making process, milk is rennet coagulated and the resulting weak high moisture gel called curd, is cut into small pieced to allow draining of liquid (whey) out of the gel network. When whey is removed from the gel network, the mechanical strength of the curd increases and enables the application of high pressure in a cheese mold, resulting in a strong and elastic structure typical for cheese, especially like semi-hard cheese.

When processing semi-hard or hard cheese analogues from non-dairy proteins and vegetable fats or oils, a very long processing time under high pressure was found to be necessary for sufficient whey drainage. Further, even such hard processing conditions and processing time did not result in a good cheese texture of vegetable-based cheese resembling semi-hard or hard, sliceable dairy cheese.

The above-mentioned problems related to the prior art are overcome in the present disclosure: pressing of the whole cheese mass or cheese curd without cutting the curd/mass during curd forming and in connection with the whey drainage preserves the continuous gel network in the curd throughout whey draining, resulting in a dense, elastic, smooth, cuttable structure that closely resembles the organoleptic textural properties of yellow dairy cheese. The resulting non-dairy cheese replica has higher hardness and clearly less that may be 5% less dry matter loss during whey drainage. The processing time is also relatively short, reduced from typical 24 h to 6 h and one processing step, that is the cutting step of the curd during the whey drainage, is eliminated.

Thus, the present invention concerns a process for producing a non-dairy cheese, wherein the process comprises the steps of
a. providing a homogenized emulsion comprising water, non-dairy protein and vegetable fat,
b. subjecting said homogenized emulsion to heat treatment at a temperature from about 60° C. to about 160° C., for about 30 seconds to about 30 minutes to obtain a heat-treated emulsion,
c. acidifying the heat-treated emulsion to obtain an acidified emulsion,
d. subjecting the acidified emulsion to an enzymatic treatment to obtain an enzyme-treated vegetable-based cheese curd,
e. cooling and hardening the cheese curd at a temperature of about 5° C. to about 45° C. for 8-12 hours to obtain a solidified vegetable-based cheese curd,
f. draining whey from the solidified cheese curd by pressing the curd mass in one piece in a cheese mold, and
g. unmolding the pressed cheese curd to obtain a non-dairy cheese block.

The present invention also relates to a non-dairy based cheese obtainable with the process of the invention.

To combat off-flavours typical for plant proteins, a combination of microbial fermentation, pH optimisation, antioxidant and flushing unwanted flavor compounds out of the product during whey drainage are used. The combination of these methods results in a mildly flavoured food product with light colour.

In present process, cheese mass is not cut into pieces after coagulation like in a prior art process (FIG. 3), but it is cooled and hardened in cold storage overnight and pressed without cutting the mass on the next day. The hardened cheese blocks are taken from the coagulation molds and put into the pressing molds. The cheese blocks are pressed for 6 hours, are taken from the molds and salted in brine.

The present method thus utilizes shorter pressing time in order to get a dense structure. Furthermore, also less dry matter is lost with whey separation, which means that more dry matter is kept in the cheese. The process of the present invention is shown in FIG. 4.

The advantages of the present invention are shown in FIGS. 5 and 6, which show that the advantages of pressing without cutting are higher hardness and higher dry matter content. The hardness comparable to dairy cheese can be achieved in 6 h instead of 24 h required for known methods. The shorter pressing time with no cutting step yielded better structure: Denser, sliceable, resembles dairy cheese. Further, the loss of dry matter along with whey separation was less compared to the longer pressing time with no cutting step process.

The characteristic features of the invention are defined in the appended claims.

### BRIEF DESCRIPTION OF THE DRAWINGS

FIG. 1 illustrates a process of manufacturing starch based non-dairy cheese.

FIG. 2a depicts non-dairy cheese pressed after curd cutting.

FIG. 2b depicts non-dairy cheese pressed without curd cutting.

FIG. 3 illustrates a process of manufacturing a protein-based cheese.

FIG. 4 illustrates a process scheme of one embodiment of the present process.

FIG. 5 depicts hardness of cheeses with different pressing times and methods, measured by TA.XT texture analysis.

FIG. 6 depicts dry matter content of non-dairy cheeses with different pressing methods.

FIGS. 7A-7C depict sensorical comparison of a cheese produced using the present process and a cheese produced using prior art (n=13). Semi-hard dairy cheese with 24% fat was used as a reference. The dairy cheese reference was always tasted first, followed by plant-based cheeses in randomised order. The evaluated attributes were “texture/mouthfeel compared to reference” and “denseness/elasticity compared to reference”. The sample produced using the process of the present disclosure scored closer to dairy reference in both attributes.

FIG. 7A depicts sensory evaluation samples. a) prior art, b) present process, c) dairy cheese reference.

FIG. 7B depicts results for texture/mouthfeel. Score 100=Totally different compared to reference, Score 0=Identical to reference.

FIG. 7C depicts denseness/elasticity. Score 100=Much denser than reference, 0=Like reference, −100=Much more brittle than reference.

FIG. 8 shows the difference between the textural and mechanical properties of the plant based cheese coagulated and pressed according to the present invention (right hand side pile of shredded cheese) and the plant-based cheese prepared traditionally cutting the curd during whey drainage and before pressing the curd in cheese pressing mold (left hand side pile of shredded cheese).

### DEFINITIONS

In the present description and claims, the following words and expressions have meanings as defined below:

A “non-dairy protein” or “dairy-free protein” is selected from the group consisting of plant proteins or vegetable proteins, insect proteins, algal proteins, microbial proteins such as bacterial, fungal, and yeast proteins, as well as recombinantly produced proteins or protein produce using a recombinant strain.

A “plant-based food product” may refer to fermented, acidified or non-acidic (neutral) food products, such as traditional dairy-based products like yoghurt, drinkable yoghurt, crème fraiche or sour cream, sour milk, quark, cream cheese (Philadelphia-type soft cheese), set-type yoghurt, smoothie or pudding. In the present disclosure “plant-based food product is especially cheese.

“Plant-based” refers to originating from plants, which are suitable for manufacturing edible food products in food technology applications. The plant-based raw material suitable for the product and process of the present invention may be from at least one plant selected from leguminous plants, such as dry and fresh beans, soybeans, dry and fresh peas, lentils, chickpeas and peanuts, more preferably selected from broad bean and pea, most preferably from broad bean.

A “legume” or leguminous plant” refers to a plant belonging to the family Fabaceae (or Leguminosae), which family is commonly known as the legume, pea, or bean family. Said family is a large family of flowering plants. A legume also refers to the fruit or seed of a leguminous plant. The seed is also called a pulse. Legumes include for example alfaalfa (Medicago sativa), clovers (Trifolium spp.), peas (Pisum), beans (Phaseolus spp., Vigna spp., Vicia spp.), chickpeas (Cicer), lentils (Lens), lupins (Lupinus spp.), mesquites (Propsis spp.), carob (Ceratonia siliqua), soybeans (Glycine max), peanuts (Arachis hypogaea), vetches (Vicia), tamarind (Tamarindus indica), kudzu (Pueraria spp.) and rooibos (Aspalathus linearis). Legumes produce a botanically unique type of fruit—a simple dry fruit that develops from a simple carpel and usually dehisces (opens along a seam) on two sides.

The terms “protein isolate” and “protein concentrate” differ in terms of protein quantity. These differences are caused by the processing methods. “Protein concentrate” powder consists of up to 80% protein by weight. The remaining 20% of the concentrate powder contains carbohydrates and fats. If different processing steps are used to reduce the fat and carbohydrate content, a “protein isolate” powder containing 90% or more protein by weight can be produced. Overall, the processing steps used in the production of isolate result in higher protein content and lower fat and carbohydrate content. However, the types of amino acids found in both forms of whey are virtually identical, since they are derived from the same proteins.

A “high-protein ingredient” refers to a protein rich ingredient that has a protein content greater than about 70% protein/dry matter. Preferably the high-protein ingredient is an isolate with a protein content in excess of about 90% protein/dry matter, preferably at least about 100% protein/dry matter, (N×6.25).

A “starter culture” is a microbiological culture, which performs fermentation. The starters usually consist of a cultivation medium, such as nutrient liquids that have been well colonized by the microorganisms used for the fermentation.

### DETAILED DESCRIPTION OF THE INVENTION

In the cheesemaking process, milk is rennet coagulated and the resulting, weak high moisture gel (curd) is cut into small pieces to allow draining of liquid (whey) out of the gel network. When liquid is removed from the gel network, the mechanical strength of the curd increases and enables the application of high pressure, resulting in a strong and elastic structure typical for cheese.

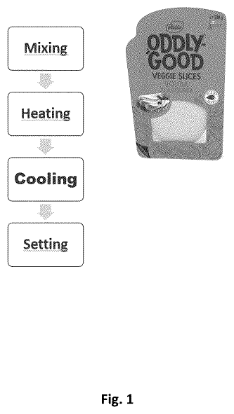

Dairy cheese is a dynamic, non-covalently cross-linked system, that develops its final structure during ripening. These structural changes include fusion of caseins into thicker fibers and partial fat globule coalescence. As a result, curd granules fuse into a solid, elastic structure. In the production of non-dairy cheese, such fusion does not occur, and cheese structure resulting from curd cutting and pressing remains crumbly or sandy, and soft, and cannot be sliced like dairy cheese (FIG. 1).

The known methods for preparing cheese analogues require a very long processing time (24 h) under high pressure for sufficient whey drainage when producing. Also, even such processing does not result in texture resembling hard, sliceable dairy cheese. The known methods are better suited for production of soft cheese replicas (goat's cheese, mold-ripened cheese or ricotta-type), but not hard, sliceable cheese.

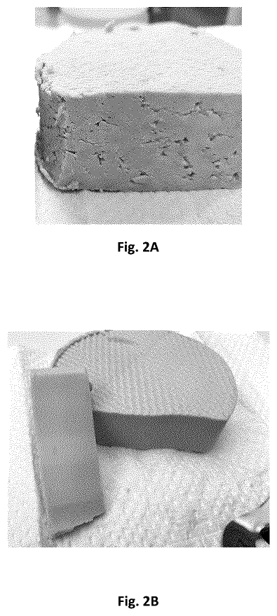

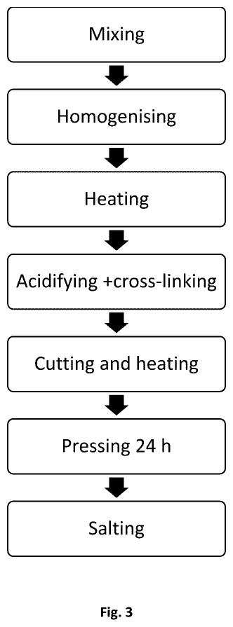

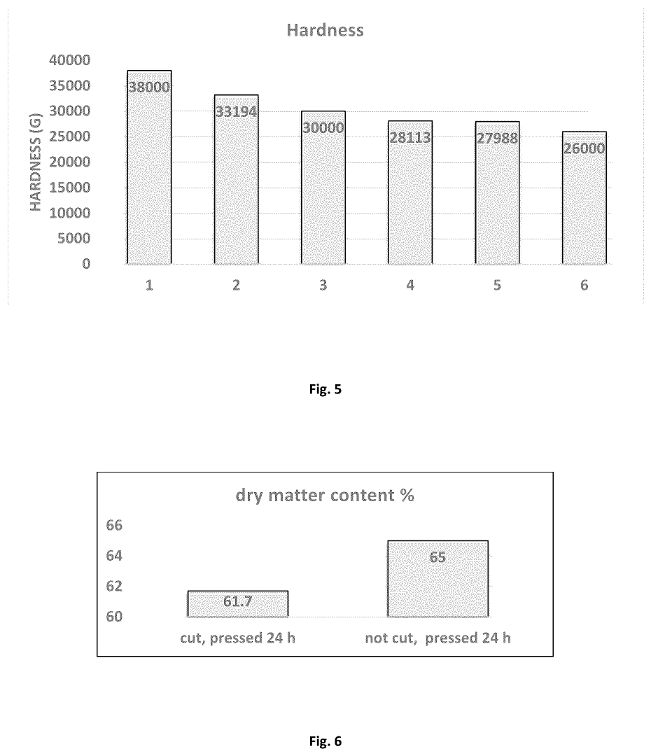

The present inventors noticed that the above-mentioned problems related to the prior art are overcome in the present disclosure: pressing of the whole cheese without cutting preserves the continuous gel network throughout whey draining, resulting in a dense, elastic, smooth, cuttable structure that closely resembles the organoleptic textural properties of yellow dairy cheese (FIG. 2b). The resulting non-dairy cheese replica has higher hardness (FIG. 5) and 5% less dry matter loss during whey drainage (FIG. 6). The processing time is also reduced from 24 h to 6 h and one processing step is eliminated making the process more economic.

The present disclosure concerns a process for producing a non-dairy cheese comprising the steps of
a. providing a homogenized emulsion comprising water, non-dairy protein and vegetable fat,
b. subjecting said homogenized emulsion to heat treatment at a temperature from about 60° C. to about 160° C., for about 30 seconds to 30 minutes to obtain a heat-treated emulsion,
c. acidifying the heat-treated emulsion to obtain an acidified emulsion,
d. subjecting the acidified emulsion to enzymatic treatment to obtain an enzyme-treated vegetable-based cheese curd,
e. cooling and hardening the cheese curd at a temperature of about 5° C. to about 45° C. for 8-12 hours to obtain a solidified vegetable-based cheese curd,
f. draining whey from the solidified cheese curd by pressing the curd mass in one piece in a cheese mold, and
g. unmolding the pressed cheese curd to obtain a non-dairy cheese block.

In one embodiment of the invention the process for producing a non-dairy cheese comprises the steps of
a. mixing water and at least one non-dairy based raw material containing non-dairy protein to obtain an aqueous protein suspension,
b. mixing vegetable fat or oil to the aqueous protein suspension,
c. homogenizing said aqueous protein suspension and the vegetable fat or oil to obtain an emulsion,
d. subjecting said homogenized emulsion to heat treatment at a temperature from about 60° C. to about 160° C., for about 30 seconds to 30 minutes to obtain a heat-treated emulsion,
e. acidifying the heat-treated emulsion to obtain an acidified emulsion,
f. subjecting the acidified emulsion to enzymatic treatment by adding a cross-linking enzyme and incubating at a temperature of 30° C. to 50° C. to obtain an enzyme-treated vegetable-based cheese curd,
g. curing the enzyme-treated vegetable-based cheese curd at a temperature of about 5° C. to about 45° C., for 8 to 12 hours to obtain a solidified vegetable-based cheese curd,
h. setting the curd in one piece without cutting into a pressing mold to drain whey from the cheese mass,
i. pressing the cheese mass in the mold for less than 24 hours, preferably for 4-6 hours, at 5 to 12 bar, preferably at 9 bar,
j. salting, and
k. obtaining a non-dairy based cheese block.

The above-mentioned steps a. to k. may be performed in succession.

In an embodiment of the present process the non-dairy based protein is selected from a protein isolate and a protein concentrate. Protein isolate and protein concentrate are protein preparations.

In an embodiment, the non-dairy protein is selected from the group consisting of plant proteins, insect proteins, algal proteins, microbial proteins such as bacterial, fungal, and yeast proteins, and recombinantly produced proteins and proteins produced using a recombinant strain.

According to an embodiment, the non-dairy protein is a plant protein, preferably a leguminous protein, preferably the leguminous protein is selected from broad bean and pea. The plant-based raw material suitable for the product and process of the present invention may be from at least one plant selected from leguminous plants, such as dry and fresh beans, soybeans, dry and fresh peas, lentils, chickpeas and peanuts, more preferably selected from broad bean and pea, most preferably from broad bean.

In an embodiment the protein is in powder form.

Typically, the homogenization is carried out at a pressure of 100 to 400 bar, preferably at a pressure of from 125 to 300 bar, more preferably at a pressure of 150 bar. The pressure may be 100, 125, 150, 200, 250, 300, 350, or 400 bar, or in the range defined by any two of these values.

Typically, the homogenized emulsion is subjected to a heat treatment at a temperature from about 60° C. to about 160° C., preferably from about 60° C. to about 78° C., more preferably at a temperature of 75° C. Heat treatment is carried out for about 30 seconds to about 30 minutes, preferably for 5 minutes to obtain a heat-treated suspension. Preferably, the homogenized emulsion is subjected to heat treatment at a temperature from about 60° C. to about 160° C., for about 30 seconds to 30 minutes to obtain a heat-treated emulsion. Typically, the higher the temperature is, the shorter the required time for heat treatment is.

The heat treatment may be carried out at a temperature of 60, 65, 70, 75, 80, 90, 100, 110, 120, 130, 140, 150, or 160° C., or in the range defined by any two of these values. The heat treatment may be carried out for 30 seconds, or 1, 2, 3, 4, 5, 6, 7, 8, 9, 10, 15, 20, 25, or 30 minutes, or in the range defined by any two of these values.

In an embodiment one or more further ingredients selected from the group consisting of fat, polysaccharides, sugars or other fermentable carbohydrates, flavorings, food colorings, fortification ingredients, preservatives, antioxidants and salt are added.

In an embodiment the fermentable carbohydrates are selected from the group consisting of added carbohydrates, endogenous carbohydrates, carbohydrates formed by hydrolysis of raw material, including glucose, sucrose, fructose, maltose, maltotriose, raffinose, stachyose, verbascose, kestoses, galactose, melibiose, cellobiose, ribose, turanose, xylose, rhamnose, arabinose, trehalose, inuline, and inositol.

In an embodiment the fat is selected from the group consisting of fats derived from plants such as canola, coconut, shea, and sunflower seed, fats derived from algae, fats derived from microbial sources, and fats produced using a recombinant strain.

In an embodiment the polysaccharide is selected from the group consisting of any gelling or otherwise texture forming polysaccharide from plants, algae or microbes, such as gellan, agar, carrageenan, pectin, xanthan, and starch.

In an embodiment the acidification is carried out microbiologically or chemically.

In an embodiment the acidification is carried out by adding a starter culture to the heat treated emulsion and incubating at a temperature from 30° C. to 50° C., more preferably at a temperature from 35° C. to 45° C., preferably at a temperature of 45° C., for 15 minutes to 1 hour, preferably for 30 minutes, at a pH from pH 4 to pH 7, preferably at pH of pH 6 to pH 6.5.

The acidification may be carried out at a temperature of 30, 31, 32, 33, 34, 35, 36, 37, 38, 39, 40, 41, 42, 43, 44, 45, 46, 47, 48, 49, or 50° C., or in the range defined by any two of these values. The acidification may be carried out at a pH of pH 4, 4.5, 5, 5.5, 6, 6.5, or 7, or in the range defined by any two of these values.

The starter culture may be selected from the group consisting of Lactococcus lactis subsp. cremoris/lactis, Lactococcus lactis subsp. Lactis biovar. diacetylactis, Leuconostoc sp.

Leuconostoc sp. includes e.g. the following: Leuconostoc mesenteroides, Leuconostoc cremoris, Leuconoston pseudomesenteroides, Leuconostoc lactis.

The starter culture may be further selected from the group consisting of: Streptococcus thermophilus, Lactobacillus delbrueckii subsp. bulgaricus, Lactobacillus acidophilus NCFM, Bifidobacterium lactis HN019, Lactobacillus delbrueckii subsp. lactis, Lactobacillus casei/paracasei, Lactobacillus plantarum, Pediococcus pentosaceus, Staphylococcus xylosus, Lactobacillus sakei, Staphylococcus carnosus, Lactobacillus helveticus, Lactobacillus fermentum, Lactobacillus curvatus, Lactobacillus rhamnosus, Lactobacillus johnsonii, Lactobacillus reuteri, Pediococcus acidilactici, Propionibacterium freudenreichii, Acidipropionibacterium thoenii, Acidipropionibacterium jensenii, Acidipropionibacterium acidipropionici, Brevibacterium linens, Brevibacterium aurantiacum, Corynebacterium casei, Corynebacterium variabile, Arthrobacter, Microbacterium, Penicillium roqueforti, Penicillium camemberti, Penicillium candidum, Geotrichum candidum, Geotrichum candidum, Saccharomyces cerevisiae, Debaromyces hansenii, Kluyveromyces lactis, Kluyveromyces marxianus, Yarrowia lipolytica, Bifidobacterium lactis, Bifidobacterium animalis, Bifidobacterium breve, Bifidobacterium longum, Bifidobacterium bifidum.

Preferably a microbe used in a starter culture is selected from the group consisting of Lactobacillus sp. and Leuconostoc sp.

According to an embodiment the enzymatic treatment in step d. is carried out using a cross-linking enzyme.

According to an embodiment, the cross-linking enzyme is selected from the group consisting of transglutaminase, tyrosinase, catechol oxidase and laccase, preferably the cross-linking enzyme is transglutaminase. However, any other transglutaminase allowed to be used in food is applicable.

According to an embodiment, the enzymatic treatment in step d. is carried at a temperature from 30° C. to 50° C., and the acidified emulsion is subjected to an enzymatic treatment using cross-linking enzyme(s) selected from the group consisting of transglutaminase, tyrosinase, catechol oxidase and laccase, preferably the cross-linking enzyme is transglutaminase.

According to an embodiment, the enzymatic treatment in step d. is carried at a temperature from 30° C. to 50° C., and the acidified emulsion is subjected to an enzymatic treatment with transglutaminase. The enzymatic treatment may be carried out at a temperature of 30, 31, 32, 33, 34, 35, 36, 37, 38, 39, 40, 41, 42, 43, 44, 45, 46, 47, 48, 49, or 50° C., or in the range defined by any two of these values.

In an embodiment the amount of cross-linking enzyme is about 0.01-1.0 wt %, preferably 0.05-0.8 wt %, more preferably 0.01-0.5 wt %, most preferably 0.5 wt % of cross-linking enzyme. The amount of cross-linking enzyme may be 0.01, 0.05, 0.1, 0.2, 0.3, 0.4, 0.5, 0.6, 0.7, 0.8, 0.9, or 1.0 wt %, or in the range defined by any two of these values.

In an embodiment curing, or solidifying, the enzyme-treated based cheese curd is preferably carried out at a temperature of about 5° C. to about 45° C., for 8-12 hours to obtain a solidified vegetable based or non-dairy cheese curd. The curd is set in one piece without cutting into a pressing mold to drain whey from the cheese mass. The solidifying may be carried out for 8, 9, 10, 11, of 12 hours, or in the range defined by any two of these values.

In an embodiment the cheese mass is pressed in the mold for less than 24 hours, preferably for 4-6 hours, at 5 to 12 bar, preferably at 9 bar. The mass may be pressed at 5, 6, 7, 8, 9, 10, 11, or 12 bar, or in the range defined by any two of these values.

Salting is carried out for the pressed cheese mass and a non-dairy based cheese block is obtained.

In an embodiment the present disclosure concerns a process for producing a non-dairy cheese, wherein the process comprises the steps of
a. providing a homogenized emulsion comprising water, non-dairy protein and vegetable fat
b. subjecting said homogenized emulsion to heat treatment at a temperature from about 60° C. to about 160° C., for about 30 seconds to about 30 minutes to obtain a heat-treated emulsion,
c. acidifying the heat-treated emulsion to obtain an acidified emulsion,
d. subjecting the acidified emulsion to an enzymatic treatment to obtain an enzyme-treated vegetable-based cheese curd,
e. cooling and hardening the cheese curd at a temperature of about 5° C. to about 45° C. for 8-12 hours to obtain a solidified vegetable-based cheese curd,
f. draining whey from the solidified cheese curd by pressing the curd mass in one piece in a cheese mold, and unmolding the pressed cheese curd to obtain a non-dairy cheese block.

In an embodiment the present disclosure concerns a process for producing a non-dairy cheese, wherein the process comprises the steps of
a. providing a homogenized emulsion comprising water, non-dairy plant-based protein and vegetable fat
b. subjecting said homogenized emulsion to heat treatment at a temperature from about 60° C. to about 160° C., for about 30 seconds to about 30 minutes to obtain a heat-treated emulsion,
c. acidifying the heat-treated emulsion to obtain an acidified emulsion,
d. subjecting the acidified emulsion to an enzymatic treatment with transglutaminase to obtain an enzyme-treated vegetable-based cheese curd,
e. cooling and hardening the cheese curd at a temperature of about 5° C. to about 45° C. for 8-12 hours to obtain a solidified vegetable-based cheese curd,
f. draining whey from the solidified cheese curd by pressing the curd mass in one piece in a cheese mold, and
g. unmolding the pressed cheese curd to obtain a non-dairy cheese block.

In an embodiment the present disclosure concerns a process for producing a non-dairy cheese, wherein the process comprises the steps of
a. providing a homogenized emulsion comprising water, non-dairy plant-based protein isolate and vegetable fat
b. subjecting said homogenized emulsion to heat treatment at a temperature from about 60° C. to about 160° C., for about 30 seconds to about 30 minutes to obtain a heat-treated emulsion,
c. acidifying the heat-treated emulsion to obtain an acidified emulsion,
d. subjecting the acidified emulsion to an enzymatic treatment with transglutaminase to obtain an enzyme-treated vegetable-based cheese curd,
e. cooling and hardening the cheese curd at a temperature of about 5° C. to about 45° C. for 8-12 hours to obtain a solidified vegetable-based cheese curd,
f. draining whey from the solidified cheese curd by pressing the curd mass in one piece in a cheese mold, and
g. unmolding the pressed cheese curd to obtain a non-dairy cheese block.

The present disclosure also concerns a non-dairy based cheese block obtainable with the process of the invention.

The present disclosure concerns a non-dairy based cheese block, comprising about 5-30 wt %, preferably about 6-25 wt %, more preferably about 10-20 wt %, most preferably 12-18 wt %, even most preferably 14 wt % of non-dairy protein, about 5-30 wt %, preferably about 10-20 wt %, more preferably about 15 wt % of vegetable fat, and about 40-70 wt %, preferably about 50-66 wt %, preferably about 50-60 wt %, more preferably 53-57 wt % of water.

Preferably the non-dairy protein is vegetable protein.

In an embodiment the non-dairy based cheese block further comprises ingredients selected from the group consisting of about 1-5 wt %, preferably 2-4 wt %, more preferably 3 wt % of sugar, about 0.0-2.0 wt %, preferably 0.5 wt % of salt, about 0.001-1.0 wt %, preferably 0.01-0.25 wt %, more preferably 0.1 wt % of antioxidant, about 0.05-1.0 wt %, preferably 0.08-0.5 wt %, more preferably 0.1 wt % of starter culture, and about 0.01-1.0 wt %, preferably 0.05-0.8 wt %, more preferably 0.01-0.5 wt %, 0.5 wt % of cross-linking enzyme, about 0.1-0.5 wt %, preferably 0.2 wt % of flavorings, and about 0.5-2.0 wt %, preferably 1.5 wt % of food colourings.

In an embodiment the non-dairy based cheese block comprises about 5-30 wt %, preferably about 6-25 wt %, more preferably about 10-20 wt %, most preferably 12-18 wt %, even most preferably 14 wt % of non-dairy protein, about 5-30 wt %, preferably about 10-20 wt %, more preferably about 15 wt % of vegetable fat, and about 40-70 wt %, preferably about 50-66 wt %, preferably about 50-60 wt %, more preferably 53-57 wt % of water, about 1-5 wt %, preferably 2-4 wt %, more preferably 3 wt % of sugar, about 0.0-2.0 wt %, preferably 0.5 wt % of salt, about 0.001-1.0 wt %, preferably 0.01-0.25 wt %, more preferably 0.1 wt % of antioxidant, about 0.05-1.0 wt %, preferably 0.08-0.5 wt %, more preferably 0.1 wt % of starter culture, and about 0.01-1.0 wt %, preferably 0.05-0.8 wt %, more preferably 0.01-0.5 wt %, 0.5 wt % of cross-linking enzyme, about 0.1-0.5 wt %, preferably 0.2 wt % of flavourings, and about 0.5-2.0 wt %, preferably 1.5 wt % of food colourings.

In an embodiment the non-dairy based cheese block comprises 14 wt % of non-dairy protein, 56.1 wt % of water, 15 wt % of vegetable fat, 3 wt % of sugar, 0.5 wt % of salt, 0.1 wt % of ascorbic acid, 0.1 wt % of starter culture, 0.5 wt % of cross-linking enzyme, 0.2 wt % of flavour and 1.5 wt % of food colour.

In an embodiment the non-dairy based cheese block comprises 14 wt % of non-dairy protein, 65.1 wt % of water, 15 wt % of vegetable fat, 3 wt % of sugar, 0.5 wt % of salt, 0.1 wt % of ascorbic acid, 0.1 wt % of starter culture, 0.5 wt % of cross-linking enzyme, 0.2 wt % of flavour and 1.5 wt % of food colour.

In an embodiment the non-dairy cheese block comprises about 0.001-1.0 wt %, preferably about 0.01-0.25 wt %, more preferably 0.1 wt % of an antioxidant, such as ascorbic acid.

The non-dairy cheese block may comprise an antioxidant and/or an ingredient with antioxidative properties selected from the group consisting of ascorbic acid, salts of ascorbic acid such as sodium ascorbate and calcium ascorbate, polyphenolic antioxidants, sulphites, bisulphites, fatty acid esters of ascorbic acid, tocopherols, tocotrienols, polyphenol antioxidants, polyphenol antioxidant containing plant extracts, eugenol, butylated hydroxyanisole, butylated hydroxytoluene, propyl gallate, erythorbic acid, salts of erythorbic acid, e.g. sodium erythorbate, extracts of rosemary, tertiary-butyl hyroquinole, butylated hydroxyanisone, butylated hydroxytoluene, and 4-hexylresorcinol.

The texture of a product, such as cheese, can be measured by TA.XT texture analyzer, performing a compression test. A compression test is the most simple and popular test of instrumental texture measurement. A sample is placed on a flat surface and a flat platen is lowered onto the sample to a given force or distance. Sample is deformed and the extent of the deformation and/or the resistance offered by the sample is recorded. Hardness, springiness (elasticity) and gumminess are measured.

Hardness is the force required to compress a cheese between the molar teeth or between the tongue and palate to a given deformation or to the point of penetration. The hardness value is the peak force that occurs during the first compression, i.e. it is expressed as the maximum force of the first compression. The hardness need not occur at the point of deepest compression, although it typically does for most products.

Springiness (elasticity) is the degree of recovery of a deformed piece of cheese after the deforming force is removed. Springiness is how well a product physically springs back after it has been deformed during the first compression and has been allowed to wait for the target wait time between strokes. The springback is measured at the downstroke of the second compression. In some cases, an excessively long wait time will allow a product to springback more than it might under the conditions being researched (e.g. you would not wait 60 seconds between chews). Springiness is expressed as a ratio or percentage of a product's original height. Springiness is measured several ways, but most typically, by the distance of the detected height during the second compression divided by the original compression distance.

Gumminess is denseness that persists through mastication, energy required to disintegrate a piece of cheese to a state ready for swallowing. Gumminess is mutually exclusive with chewiness since a product would not be both a semi-solid and a solid at the same time.

The non-dairy cheese block of the present disclosure has the following characteristics. hardness of 5 000-40 000 g, preferably 20 000-30 000 g, more preferably 26 000 g, springiness of 0.3-0.9, preferably 0.6-0.8, more preferably 0.8, and gumminess of 2000-14 000, preferably 8 000-12 000, more preferably 11 785.

The hardness may be such as 5 000 g, 10 000 g, 15 000 g, 20 000 g, 21 000 g, 22 000 g, 23 000 g, 24 000 g, 25 000 g, 26 000 g, 27 000 g, 28 000 g, 29 000 g, 30 000 g, 31 000 g, 32 000 g, 33 000 g, 34 000 g, 35 000 g, 36 000 g, 37 000 g, 38 000 g, 39 000 g, or 40 000 g, or in the range defined by any two of these values.

The springiness may be such as 0.3, 0.4, 0.5, 0.6, 0.7, 0.8, or 0.9, or in the range defined by any two of these values.

The gumminess may be such as 2 000, 3 000, 4 000, 5 000, 6 000, 7 000, 8 000, 9 000, 10 000, 11 000, or 12,000, or in the range defined by any two of these values.

Springiness and gumminess are computational parameters and relative measures.

In a preferred embodiment, the non-dairy based cheese block has the hardness of 20 000-30 000 g, more preferably 26 000 g, springiness of 0.6-0.9, more preferably 0.8, and gumminess of 8 000-12 000, more preferably 11 785.

Protein content was analyzed using the method ISO 8968-1, IDF 20-1:2014; fat content by method ISO 1735, IDF 5:2004 and dry matter content by ISO 6731, IDF 21:2010. The carbohydrate content was calculated based on the fat, protein and dry matter content.

The present invention is further illustrated with the following examples.

### EXAMPLES

### Example 1

### Cheese Replica

A protein based non-dairy cheese, that has a texture similar to semi-hard dairy cheeses was produced. The recipe for producing a protein based non-dairy cheese of the present disclosure is presented in Table 1.

TABLE 1
Ingredients of protein based non-dairy cheese.

| RECIPE | % |
|---|---|
| Plant protein isolate | 14 |
| Water | 65.1 |
| Vegetable fat | 15 |
| Sugar | 3 |
| Salt | 0.5 |
| Ascorbic acid | 0.1 |
| Starter culture | 0.1 |
| Cross-linking enzyme | 0.5 |
| Flavor | 0.2 |
| Food colour | 1.5 |
| TOTAL | 100 |

The process for producing a non-dairy cheese replica was as follows: The plant protein isolate was mixed with water. Other raw materials (fat, sugar, salt and food colour) were added, the mixture was heated to 60° C. and homogenized at 150 bar.

The mixture was further pasteurised at 75° C., for 5 min and cooled to incubation temperature (45° C.). The starter culture, ascorbic acid and flavor were added, and the mixture was fermented about 30 min to pH 5.8-6.8. After that cross-linking enzyme (transglutaminase, Ajinomoto) was added, the mixture was poured to coagulation molds and the mixture was coagulated for 2 hours to pH 4.5-5.9. The mass was further hardened in cold store (4-6° C.) for 12 hours. The cheese mass was then moved to pressing molds and the excess whey was pressed out by a hydraulic press (9 bar 4-6 hours). After pressing the cheese replicas were salted in brine or by dry salting.

To combat off-flavours typical for plant proteins, a combination of microbial fermentation, pH optimisation, antioxidant and flushing unwanted flavour compounds out of the product during whey drainage were used. The combination of these methods results in a mildly flavored product with light colour.

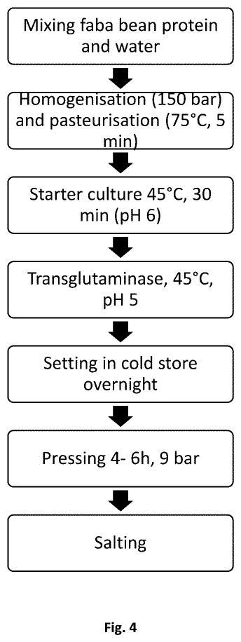

In present process, cheese mass was not cut into pieces after coagulation, but it was cooled and hardened in cold storage overnight and pressed without cutting the mass on the next day. The hardened cheese blocks were taken from the coagulation molds and put into the pressing molds. The cheese blocks were pressed for 6 hours, were taken from the molds and salted in brine. Using this method, there was shorter pressing time in order to get a dense structure and there was also less dry matter lost with whey separation, which means that more dry matter was kept in the cheese. The process of the present invention is shown in FIG. 4.

The hardness of cheese was measured by TA.XT texture analyser, performing a compression test. A compression test is the most simple and popular test of instrumental texture measurement. A sample was placed on a flat surface and a flat platen was lowered onto the sample to a given force or distance. Sample was deformed and the extent of the deformation and/or the resistance offered by the sample was recorded. The analysis used was TPA75 (texture profile analysis, irreversible method, 75%). The probe was P75, the product analysed was compressed 75% of its initial height in 2 stages.

The advantages of the present invention are presented in FIGS. 5 and 6 showing that the pressing without cutting results in higher hardness and higher dry matter content. The hardness comparable to dairy cheese can be achieved in 6 h compared to 24 h required in previously known methods. The shorter pressing time with no cutting step yielded better structure: Denser, sliceable structure, which resembles dairy cheese. Further, the loss of dry matter along with whey separation was less compared to the longer pressing time with no cutting step process.

The cheeses compared by TA.XT texture analysis are presented in Table 2. The texture of a non-dairy cheese replica produced by our process resembled semi-hard dairy cheese as presented in Table 4.

TABLE 2
Cheeses compared by TA.XT texture analysis.

| | |
|---|---|
| 1 | Present invention (not cut, pressed 24 h) |
| 2 | Keisarinna (Gouda, matured 7 months, 30% fat) |
| 3 | Present invention (cut, pressed 24 h) |
| 4 | Oltermanni (semi-hard cheese, 29% fat) |
| 5 | Ritari (semi-hard cheese, matured 9 months, 32 % fat) |
| 6 | Present invention (not cut, pressed 6 h) |

The dry matter content of cheeses pressed by different methods was chemically analyzed using the method ISO 6731:2010 (Milk, cream and evaporated milk—determination of total solids content). The results are presented in FIG. 6.

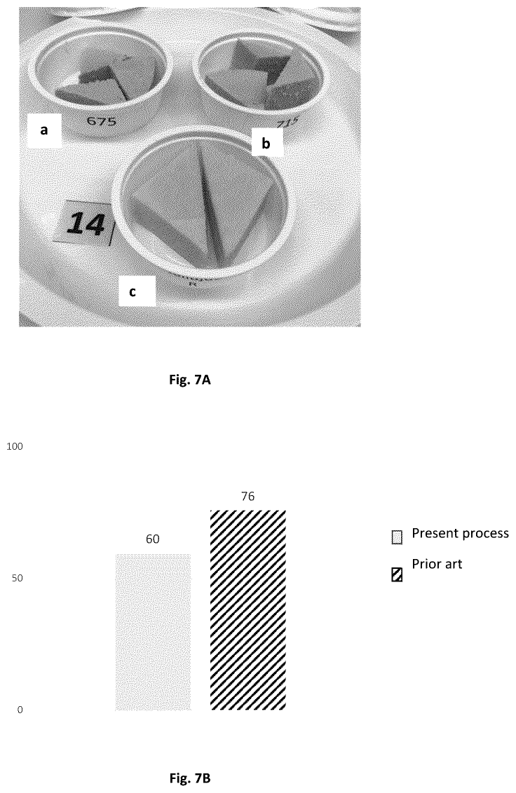

Cheese produced using the present process and cheese produced using a known method were compared sensorically (n=13). Semi-hard dairy cheese with 24% fat was used as a reference. The dairy cheese reference was always tasted first, followed by plant-based cheeses in randomised order. The evaluated attributes were “texture/mouthfeel compared to reference” and “denseness/elasticity compared to reference”. The sample produced using the present invention scored closer to dairy reference in both attributes (FIGS. 7A-7C).

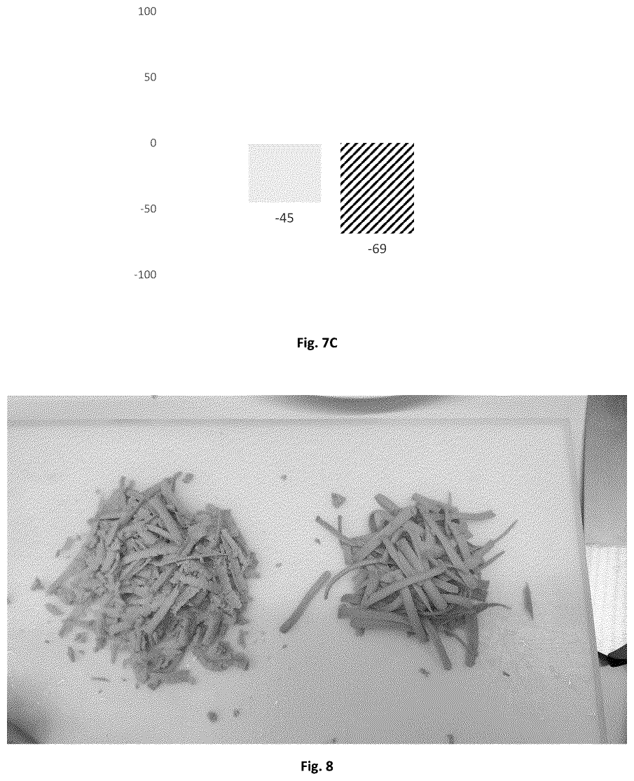

FIG. 8 shows the difference between the textural and mechanical properties of the plant based cheese coagulated and pressed according to the present invention (right hand side pile of shredded cheese) and the plant-based cheese prepared traditionally cutting the curd during whey drainage and before pressing the curd in cheese pressing mold (left hand side pile of shredded cheese). The cheese manufactured according to the present invention does not crumble of crack up and keeps it shape also in shredded form. The cheese whey drained and cut before pressing crumbles and cracks up losing its good shape of shredded cheese.

### Example 2

### Semi-Hard Cheese Replica

The cheese replica produced with the process of the present disclosure also comprises protein and fat and is much closer to dairy cheese (FIG. 2 b) than the previously existing products. The chemical composition of the non-dairy cheese of the invention compared to a starch based non-dairy cheese and a dairy cheese is presented in Table 3.

TABLE 3
Nutritional composition of plant protein-based cheese
of the present disclosure, starch-based non-dairy cheese
(Valio Veggie) and dairy cheese (Valio Oltermanni).

| | Protein | Fat | Carbohydrates |
|---|---|---|---|
| Cheese | (g/100 g) | (g/100 g) | (g/100 g) |
| Non-dairy cheese of the present | 20 | 25 | 3 |
| disclosure | | | |
| Starch-based non-dairy cheese | 1 | 21 | 18 |
| (Valio Veggie) | | | |
| Dairy cheese (Valio Oltermanni) | 25 | 29 | 0 |

TABLE 4
Texture analysis of cheeses

| Cheese | Hardness (g) | Springiness | Gumminess |
|---|---|---|---|
| Valio Oltermanni | 28113 | 0.7 | 12000 |
| (semi-hard cheese, 29% fat) | | | |
| Non-dairy cheese of the | 26000 | 0.8 | 11785 |
| present disclosure (25% fat) | | | |

### Example 3

### Plant-Based Cheese

A fava bean protein isolate was prepared as follows: 0.02 wt % sodium sulphite (Na₂SO₃) was solubilized in water with 8 wt % air classified fava bean protein concentrate flour after mixing, 0.1 wt % ascorbic acid was solubilized into the suspension. pH of the suspension was adjusted to pH 7.0 using sodium hydroxide and suspension was then mixed at room temperature for 90 minutes. The suspension was clarified by removal of insoluble solids with a decanter centrifuge and nozzle-bowl separator. The clarified suspension was enzymatically treated by adding 0.1 wt % of a commercial enzyme with known tannase activity (Viscozyme L, Novozymes) and incubated for 30 minutes at room temperature under constant mixing. After this enzyme was inactivated by heat-treatment at 80° C. for 5 minutes. Heat-treated suspension was then concentrated with ultrafiltration using 10 kDa spiral-wound membrane and rinsed with diafiltration. Optionally, subsequently concentrated fava bean protein retentate can be then spray dried to produce dried fava bean protein isolate.

In order to determine structural forming properties a fava bean protein isolate was tested in a vegan cheese application. The fava bean protein isolate was mixed with water and other raw materials (fat, sugar, salt and food colour) were added into the mixture. The mixture was heated to 60° C. and homogenized at 150 bar. The mixture was further pasteurized at 75° C., for 5 min and cooled down to incubation temperature (45° C.). Then the microbial starter culture, ascorbic acid and flavor were added, and the mixture was fermented about 30 min to pH 6.0. After that transglutaminase (Ajinomoto Foods) enzyme was added, the mixture was poured to coagulation molds and the mixture was coagulated for 2 hours to pH 5.0. The mass was further hardened in cold store (4-6° C.) around 12 hours. The cheese mass was then moved to pressing molds and the excess whey was pressed out by a hydraulic press (9 bar 4-6 hours). After pressing the vegan cheeses were dry salted.

### REFERENCES

Everett, D. W. 2007. Microstructure of natural cheeses In: A. Y. Tamime (Ed.), Structure of dairy products, Blackwell Publishing Ltd., Oxford, UK.
Mintel, 2019. What's holding back alternative cheese? Powerpoint presentation by Jane Hurh, April 2019.
Oyeyinka, A. T., Odukoya, J. O. and Adebayo, Y. S., 2019. Nutritional composition and consumer acceptability of cheese analog from soy and cashew nut milk. Journal of Food Processing and Preservation, 43(12), p.e14285.
CA3058199A1
EP273145113.1
EP3366144A1
U.S. Pat. No. 6,042,851A
U.S. Pat. No. 9,011,949B2
US2017/0172169A1
US20180000105A1
US20190037872A1
WO2019133679A2

1.-24. (canceled)

25. A process for producing a non-dairy cheese, wherein the process comprises the steps of:
a. providing a homogenized emulsion comprising water, non-dairy protein and vegetable fat,
b. subjecting said homogenized emulsion to heat treatment at a temperature from about 60° C. to about 160° C., for about 30 seconds to 30 minutes to obtain a heat-treated emulsion,
c. acidifying the heat-treated emulsion to obtain an acidified emulsion,
d. subjecting the acidified emulsion to enzymatic treatment to obtain an enzyme-treated vegetable-based cheese curd,
e. cooling and hardening the cheese curd at a temperature of about 4° C. to about 45° C. for 8-12 hours to obtain a solidified vegetable-based cheese curd,
f. draining whey from the solidified cheese curd by pressing the curd mass in one piece in a cheese mold, and
g. unmolding the pressed cheese curd to obtain a non-dairy cheese block.

26. The process according to claim 25, wherein the source of the non-dairy protein is a protein isolate or a protein concentrate.

27. The process according to claim 25, wherein the non-dairy protein is selected from the group consisting of plant proteins, insect proteins, algal proteins, microbial proteins such as bacterial, fungal, and yeast proteins, including recombinantly produced proteins and proteins produced using a recombinant strain.

28. The process according to claim 25, wherein the non-dairy protein is a plant protein.

29. The process according to claim 25, wherein the protein is in powder form.

30. The process according to claim 25, wherein the homogenized emulsion is in step b. subjected to a heat treatment at a temperature between 60° C. and 78° C.

31. The process according to claim 25, wherein one or more further ingredients selected from the group consisting of fat, polysaccharides, sugars or other fermentable carbohydrates, flavourings, colourings, fortification ingredients, preservatives, antioxidants and salt are added.

32. The process according to claim 31, wherein the fermentable carbohydrates are selected from the group consisting of added carbohydrates, endogenous carbohydrates, carbohydrates formed by hydrolysis of raw material, including glucose, sucrose, fructose, maltose, maltotriose, raffinose, stachyose, verbascose, kestoses, galactose, melibiose, cellobiose, ribose, turanose, xylose, rhamnose, arabinose, trehalose, inuline, and inositol.

33. The process according to claim 25, wherein the fat is selected from the group consisting of fats derived from plants such as canola, coconut, shea, and sunflower seed, fats derived from algae, fats derived from microbial sources, fats produced using a recombinant strain.

34. The process according to claim 31, wherein polysaccharide is selected from the group consisting of any gelling or otherwise texture forming polysaccharide from plants, algae or microbes, such as gellan, agar, carrageenan, pectin, xanthan, or starch.

35. The process according to claim 25, wherein in step c. the acidification is carried out microbiologically or chemically.

36. The process according to claim 25, wherein in step c. the acidification is carried out by adding a starter culture to the heat-treated emulsion and incubating at a temperature from 30° C. to 50° C.

37. The process according to claim 25, wherein the enzymatic treatment in step d. is carried out using a cross-linking enzyme selected from the group consisting of transglutaminase, tyrosinase, catechol oxidase and laccase.

38. The process according to claim 25, wherein the enzymatic treatment in step d. is carried at a temperature from 30° C. to 50° C., and the acidified emulsion is subjected to an enzymatic treatment using cross-linking enzyme(s) selected from the group consisting of transglutaminase, tyrosinase, catechol oxidase and laccase.

39. The process according to claim 25, wherein the enzymatic treatment in step d. is carried at a temperature from 30° C. to 50° C., and the acidified emulsion is subjected to an enzymatic treatment with transglutaminase.

40. The process according to claim 25, wherein the amount of cross-linking enzyme is about 0.01-1.0 wt %.

41. The process according to claim 25, wherein the enzymatically treated vegetable-based cheese curd is coagulated for 2 hours to pH 4.5-5.9.

42. The process according to claim 25, wherein cooling and hardening the cheese curd is carried out at a temperature of about 4° C. to about 6° C. for 8-12 hours.

43. A non-dairy based cheese block obtainable with the process according to claim 25.

44. A non-dairy based cheese block, wherein it comprises:
about 5-30 wt % of vegetable protein,
about 5-30 wt % of vegetable fat, and
about 40-70 wt % of water.

45. The non-dairy based cheese block according to claim 44, wherein it further comprises ingredients selected from the group consisting of about 1-5 wt % of sugar,
about 0.0-2.0 wt % of salt,
about 0.001-1.0 wt % of antioxidant,
about 0.05-1.0 wt % of starter culture,
about 0.01-1.0 wt % of cross-linking enzyme,
about 0.1-0.5 wt % of flavorings, and
about 0.5-2.0 wt % of food colourings.

46. The non-dairy based cheese block according to claim 44, wherein it comprises 14 wt % of non-dairy protein, 65.1 wt % of water, 15 wt % of vegetable fat, 3 wt % of sugar, 0.5 wt % of salt, 0.1 wt % of ascorbic acid, 0.1 wt % of starter culture, 0.5 wt % of cross-linking enzyme, 0.2 wt % of flavor, and 1.5 wt % of food colour.

47. The non-dairy based cheese block according to claim 44, wherein the cheese block has hardness of 5 000-40 000 g.

48. The non-dairy based cheese block according to claim 47, wherein the cheese block has the hardness of 20 000-30 000 g.
